(19) United States
(12) Patent Application Publication
(10) Pub. No.: US 2015/0275999 A1
(43) Pub. Date: Oct. 1, 2015

(54) DAMPING FORCE ADJUSTABLE SHOCK ABSORBER

(71) Applicant: HITACHI AUTOMOTIVE SYSTEMS, LTD., Ibaraki (JP)

(72) Inventors: Shunsuke MORI, Yokohama-shi (JP); Mikio YAMASHITA, Zama-shi (JP)

(21) Appl. No.: 14/662,635

(22) Filed: Mar. 19, 2015

(30) Foreign Application Priority Data
Mar. 31, 2014 (JP) 072022/2014

(51) Int. Cl. F16F 9/32; F16F 9/348; F16F 9/18

(52) U.S. Cl. CPC F16F 9/3285; F16F 9/18; F16F 9/348

(57) ABSTRACT

A damping force adjustable shock absorber includes a cylinder sealingly containing hydraulic fluid, a piston slidably fitted in the cylinder, a piston rod coupled to the piston, and a damping force generation mechanism configured to generate a damping force by controlling a flow of the hydraulic fluid caused by a sliding movement of the piston. The damping force generation mechanism includes a pilot-type damping valve. A valve body of the pilot-type damping valve and a plurality of annular members including a member forming a pilot chamber are fixed to a shaft-like member inserted therethrough with a space formed between one of the annular member and the shaft-like member, and at least one of a filter and a fixed orifice is disposed in the space.

### BACKGROUND OF THE INVENTION

The present invention relates to a damping force adjustable shock absorber that generates a damping force against a stroke of a piston rod by controlling a flow of fluid, and can adjust this damping force.

Generally, a shock absorber mounted on a suspension apparatus of a vehicle such as an automobile includes a piston with a piston rod coupled thereto that is slidably fitted in a cylinder sealingly containing fluid, and is configured to generate a damping force against a stroke of the piston rod by controlling a flow of the fluid caused by a sliding movement of the piston in the cylinder with use of a damping force generation mechanism including an orifice, a disk valve, and the like.

Further, for example, a hydraulic shock absorber discussed in Japanese Patent Application Public Disclosure No. 2009-281584 includes a backpressure chamber (a pilot chamber) formed behind a main disk valve, which is a damping force generation mechanism, and is configured to control valve opening of the main disk valve by introducing fluid into the backpressure chamber via a fixed orifice to cause an inner pressure in the backpressure chamber to be applied to the main disk vale in a valve-closing direction, and adjusting the inner pressure in the backpressure chamber with use of a solenoid valve (a pilot valve). This configuration allows the shock absorber to store flexibly and freely adjust a damping force characteristic.

Because the fixed orifice has a considerably small area of a flow passage in such a pilot-type damping force adjustable shock absorber, a filter for catching a foreign object in oil is desired to be provided to prevent the fixed orifice from being clogged. In this case, there arises a problem about where the filter should be disposed. For example, if the filter is disposed at an outer circumferential portion of the piston rod, and the piston and a disk valve are disposed on an outer circumferential portion of the filter, this leads to an increase in an inner diameter of the disk valve, resulting in an increase in the stiffness of the disk valve and thus an increase in a soft-side damping force. Further, enlarging an outer diameter of the disk valve to reduce the stiffness leads to an increase in the size of the damping force adjustable shock absorber.

### SUMMARY OF INVENTION

The present invention has been contrived in consideration of the above-described circumstances, and an object thereof is to allow the damping force adjustable shock absorber including the pilot-type damping force generation mechanism to maintain a required adjustable range of the damping force characteristic while including the filter for preventing the fixed orifice, which introduces the fluid into the pilot chamber, from being clogged without requiring an increase in the size of the shock absorber.

To achieve the above-described object, according to one aspect of the present invention, a damping force adjustable shock absorber includes a cylinder sealingly containing hydraulic fluid, a piston slidably fitted in the cylinder, a piston rod coupled to the piston and extending out of the cylinder, and a damping force generation mechanism configured to generate a damping force by controlling a flow of the hydraulic fluid that is caused by a sliding movement of the piston in the cylinder. The damping force generation mechanism includes a pilot-type damping valve configured to be opened by receiving a pressure of the hydraulic fluid to generate the damping force. The pilot-type damping valve has a valve-opening pressure adjusted according to an inner pressure in a pilot chamber into which the hydraulic fluid is introduced. A valve body of the pilot-type damping valve and a plurality of annular members including a member forming the pilot chamber are fixed to a shaft-like member inserted therethrough with a space formed between one of the annular members and the shaft-like member. At least one of a filter and a fixed orifice is disposed in the space.

### BRIEF DESCRIPTION OF DRAWINGS

FIG. 1 is a vertical cross-sectional view illustrating main parts of a damping force adjustable shock absorber according to a first embodiment of the present invention.

FIG. 2 is an enlarged view illustrating the main parts of the damping force adjustable shock absorber illustrated in FIG. 1.

FIG. 3 is an enlarged vertical cross-sectional view illustrating main parts of a damping force adjustable shock absorber according to a second embodiment of the present invention.

FIG. 4 is an enlarged vertical cross-sectional view illustrating main parts of a damping force adjustable shock absorber according to a third embodiment of the present invention.

### DESCRIPTION OF EMBODIMENTS

In the following description, embodiments of the present invention will be described in detail with reference to the accompanying drawings.

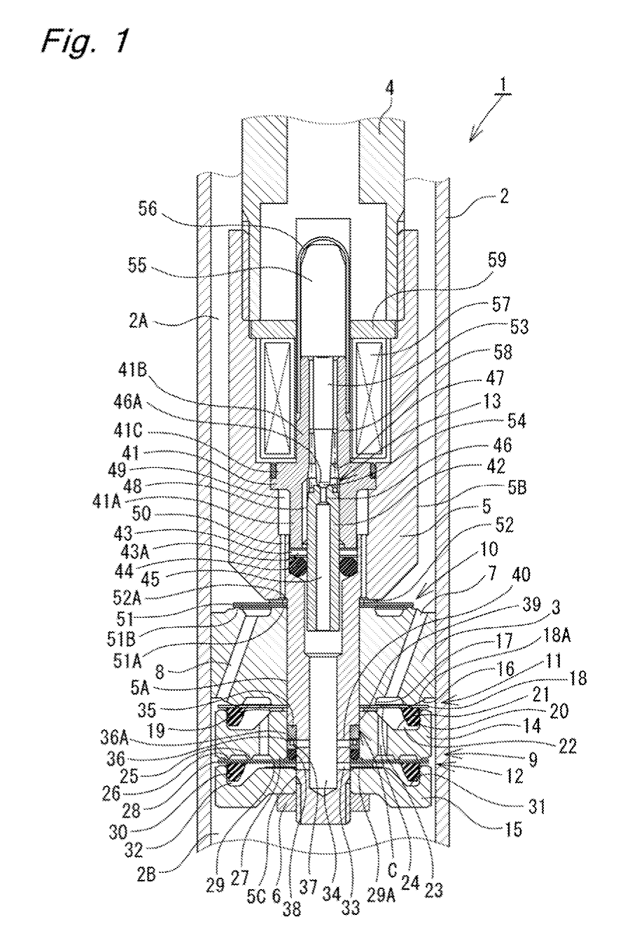

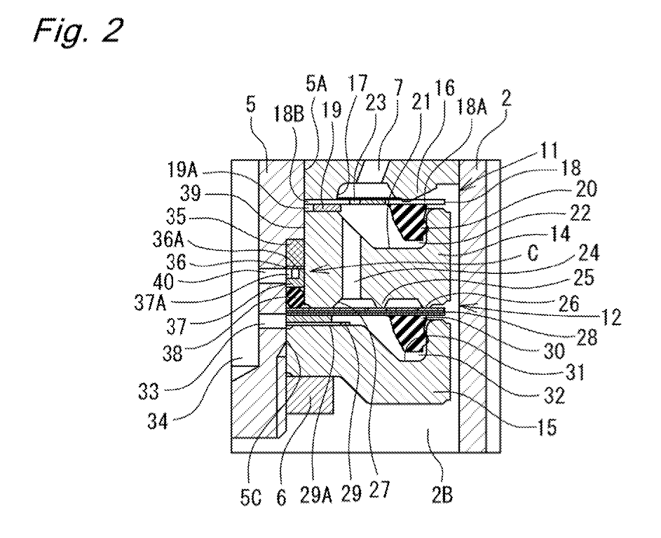

A first embodiment of the present invention will be described with reference to FIG. 1 and 2.

As illustrated in FIG. 1, a damping force adjustable shock absorber 1 according to the present embodiment is a cylindrical shock absorber mounted on a suspension apparatus of an automobile. The damping force adjustable shock absorber 1 includes a cylinder 2 sealingly containing oil as hydraulic fluid or wording fluid, a piston 3 slidably inserted in the cylinder 2 to divide the inside of the cylinder 2 into two chambers, a cylinder upper chamber 2A and a cylinder lower chamber 2B, and a piston rod (4, 5) having one end coupled to the piston 3 and an opposite end extending out of the cylinder 2. The damping force adjustable shock absorber 1 generates a damping force against extension and compression of the piston rod (4, 5), i.e., a stroke of the piston rod (4, 5). The damping force adjustable shock absorber 1 compensates for a change in the volume of the cylinder 2 according to the stoke of the piston rod (4, 5) by including a gas chamber defined by a free piston (not illustrated) in the cylinder 2, or including a reservoir (not illustrated) connected to the cylinder 2.

A piston rod body 4 is coupled to the piston 3 via a stepped cylindrical piston bolt 5 including a small-diameter portion 5A, a large-diameter portion 5B, and a distal end portion 5C smaller in diameter than the small-diameter portion 5A. The piston bolt 5 is fixed to the piston 3 by insertion of the small-diameter portion 5A through the piston 3, which is an annular member, and threaded engagement of a nut 6 with the distal end portion 5C of the piston bolt 5. The piston rod body 4 is fixed to the piston bolt 5 by being inserted in or screwed into the large-diameter portion 5B of the piston bolt 5. The piston bolt 5 is a shaft-like member constituting a part of the piston rod 4, 5.

A plurality of passages 7 and a plurality of passages 8 (only one of each is illustrated), which establish communication between the cylinder upper and lower chambers 2A and 2B, penetrate through the piston 3. Further, an extension-side damping force generation mechanism 9, which generates a damping force by controlling mainly flows of the oil through the passages during an extension stroke of the piston rod (4, 5), and a compression-side damping force generation mechanism 10, which generates a damping force by controlling mainly flows of the oil through the passages 8 during a compression stroke of the piston rod (4, 5), are provided at the piston rod 3.

The extension-side damping force generation mechanism 9 includes a main valve 11 that is a pilot-type damping valve for controlling the flows of the oil through the passages 7, a pilot-type control valve 12 that controls valve opening of the main valve 11, and a pilot valve 13 that is a solenoid-driven pressure control valve for controlling valve opening of the control valve 12. The extension-side damping force generation mechanism 9 is set in a main body 14 mounted on the small-diameter portion 5A of the piston bolt 5 and a control body 15 while being also set in the piston 3 and the piston bolt 5. The main body 14 and the control body 15 are annular members, and are stacked in this order at one end of the piston 3 (a lower end in FIG. 1). The small-diameter portion 5A and the distal end portion 5C of the piston bolt 5 are inserted through the main body 14 and the control body 15, and the main body 14 and the control body 15 are fixed to the piston belt 5 by the nut 6.

On the one end of the piston 3, an annular seat portion 16 protrudes on an outer circumferential side of openings of the plurality of passages 7, and an annular clamp portion 17 protrudes on an inner circumferential side of the openings of the plurality of passages 7. An outer circumferential portion of a disk valve 18, which constitutes the main valve 11, is seated on the seat portion 16. An inner circumferential portion of the disk valve 18 is clamped between the clamp portion 17 and the main body 14 together with an annular retainer 19. An annular elastic seal member 20 made of an elastic material such as rubber is fixedly attached to the outer circumferential portion of the disk valve 18 on a back surface side of the disk valve 18 by a fixing method such as cure adhesion or vulcanization adhesion. An orifice 18A is formed on the outer circumferential portion of the disk valve 18 by cutting out the disk valve 18. As the disk valve 18, valve bodies may be stacked so as to acquire a desired deflection characteristic as appropriate.

An annular recessed portion 21 is formed on a one-end side of the main body 14. An outer circumferential portion of the elastic seal member 20 fixedly attached to the disk valve 18 is slidably and liquid-tightly fitted in this recessed portion 21, thereby forming a pilot chamber 22 in the recessed portion 21. The disk valve 18 is lifted from the seat portion 16 to be opened by receiving a pressure of the oil on the passage 7 side, thereby establishing direct communication between the passages 7 and the cylinder lower chamber 2B. An inner pressure in the pilot chamber 22 is applied to the disk valve 18 in a valve-closing direction. The pilot chamber 22 is in communication with the passages 7 via a fixed orifice 23 formed at the disk valve 18.

A plurality of passages 24, which axially penetrates through the main body 14 and have one ends in communication with the pilot chamber 22, is formed through the main body 14 along a circumferential direction. On an opposite-end side of the main body 14, an annular inner seat portion 25 protrudes on an outer circumferential side of openings of the plurality of passages 24, and an outer seat portion 26 protrudes on an outer circumferential side of the inner seat portion 25. Further, an annular clamp portion 27 protrudes on an inner circumferential side of the plurality of passages 24. A disk valve 28, which constitutes the control valve 12, is seated on the inner and outer seat portions 25 and 26. An inner circumferential portion of the disk valve 28 is clamped between the clamp portion 2 and the control body 15 together with a washer 29. An annular elastic seal member 30 made of an elastic material such as rubber is fixedly attached to an outer circumferential portion of the disk valve 28 on a back surface side of the disk valve 28 by a fixing method such as the cure adhesion or vulcanization adhesion. As the disk valve 28, flexible disk-like valve bodies are stacked so as to acquire a desired deflection characteristic as appropriate.

An annular recessed portion 31 is formed at the control body 15. An outer circumferential portion of the elastic seal member 30 fixedly attached to the disk valve 23 is slidably and liquid-tightly fitted in this recessed portion 31, thereby forming a pilot chamber 32 in the recessed portion 31. The disk valve 28 is lifted from the outer seat portion 26 and the inner seat portion 25 in this order to be opened by receiving a pressure of the oil on the passage 24 side in communication with the pilot chamber 22 of the main valve 11, and eventually, establishes direct communication between the passages 24 and the cylinder lower chamber 2B. An inner pressure in the pilot chamber 32 is applied to the disk valve 23 in a valve-closing direction. The pilot chamber 32 is in communication with a passage 34 in the small-diameter portion 5A and the distal end portion 5C via a cutout 29A formed at the washer 29 and the passage 33 formed through a sidewall of the distal end portion 5C of the piston bolt 5.

Referring to FIG. 2, an annular space C is formed between an inner circumferential portion of the main body 14 with the small-diameter portion 5A inserted therethrough, and an outer circumferential portion of the distal end portion 5C smaller in diameter than the small-diameter portion 5A. The control body 15 is fitted to the distal end portion 5C, and the nut 6 is threadedly engaged with the distal end portion 5C. An annular filter member 35, an orifice member 36, a spacer 37, and a seal, member 38 are fitted in the annular space C in this order from the small-diameter portion 5A side. These members, i.e., the filter member 35, the orifice member 36, the spacer 37, and the seal member 38 are axially fixed between a stepped portion between the small diameter portion 5A and the distal end portion 5C, and the inner circumferential portion of the disk valve 28 clamped by the clamp portion 27 of the main body 14.

Further, a gap is formed between an outer circumferential surface of the small-diameter portion 5A of the piston bolt 5 and an inner circumferential surface of the main body 14 by fitted attachment therebetween. A passage 39 for the oil is formed from this space. The passage 39 may be formed by formation of an axial groove on at least one of the outer circumferential surface of the small-diameter portion 5A of the piston bolt 5 and the inner circumferential surface of the main body 14. The passages 7 of the piston 3 and the space C are in communication with each, other via this passage 39, cutouts 18B and 19A formed at the inner circumferential portions of the disk valve 18 and the retainer 19. The space C is in communication with the passage 34 in the piston bolt 5 via a passage 40 facing the spacer 37 and penetrating through a sidewall of the distal end portion 5C of the piston bolt 5.

A fixed orifice 36A is formed at the orifice member 36. A cutout 37A is formed at the spacer 37 for allowing the oil to flow from the fixed orifice 36A into the passage 40. The filter 35 functions to catch a foreign object in the oil flowing from the passage 39 to the fixed orifice 36A for the purpose of preventing the fixed orifice 36A considerably small in diameter from being clogged. The seal member 38 seals between the inner circumferential surface of the main body 14 and an outer circumferential surface of the distal end portion 5C of the piston bolt 5, thereby forming a flow passage of the oil between the passages 39 and 40.

Referring to FIG. 1, a pilot valve 13, which is a solenoid valve, is fixed by being inserted inside the large-diameter portion 5B of the piston bolt 5, and by the piston rod body 4 being inserted in or screwed into the piston bolt 5. The pilot valve 13 includes a guide member 41 formed into a stepped cylindrical shape. The guide member 41 includes a port press-fitting portion 41A small in diameter on a one-end side, a plunger guide portion 41B small in diameter on an opposite-end side, and a large-diameter portion 41C at an intermediate portion. A generally cylindrical port member 42 is press-fitted to be fixed in the port press-fitting portion 41A of the guide member 41. An annular retainer 43 and an O-ring 44 are provided at a distal end of the pert press-fitting portion 41A, and the O-ring 44 seals between the passage 34 in the piston bolt 5 and the port member 42 inserted in the passage 34. A passage 45 in the port member 42 is in communication with the passage 34 in the piston bolt 5.

A port 46 defined by reducing an inner diameter of the passage 45 is formed at an end of the port member 42 that is press-fit ted in the guide member 41, and the port 46 is open to the inside of a valve chamber 47 formed in the guide member 41. The valve chamber 47 is in communication with the cylinder lower chamber 3B via an axial groove 48 formed in the port press-fitting portion 41A of the guide member 41, a passage 43A formed at the spacer 43, an annular chamber 49 formed between an inner circumferential portion of one large-diameter portion 5B of the piston bolt 5 and an outer circumferential surface of the port press-fitting portion 41A of the guide member 41, a passage 50 extending from the annular chamber 49 toward an end of the large-diameter portion 5B of the piston bolt 5 along the axial direction, cutouts 51A and 52A formed at inner circumferential portions of a disk valve 51 constituting the compression-side damping force generation mechanism 10 and a retainer 52 holding the disk valve 51, and the passages 8 of the piston 3.

A plunger 53 is inserted in the plunger guide portion 41B of the guide member 41, and is slidably guided along the axial direction. A tapering valve body 54 is provided at a distal end of the plunger 53. The valve body 54 is inserted in the valve chamber 47 of the guide member 41, and opens and closes the port 46 by being separated from and seated onto a seat portion 46A at the end of the port member 42. An armature 55 large in diameter is provided at a proximal end of the plunger 53. The armature 55 is disposed outside the plunger guide portion 41B. A generally bottomed cylindrical cover 56 covering the armature 55 is attached to the plunger guide portion 41B. The cover 56 slidably guides the armature 55 along the axial direction.

A coil 57 is disposed around the plunger guide portion 41B and the cover 56. A lead wire (not illustrated) connected to the coil 57 is inserted through the hollow piston rod body 4 and extends out of a distal end of the piston rod body 4. The plunger 53 is urged by a spring force of a return spring 58 disposed between the plunger 53 and the pore member 42 in a valve-opening direction for causing the valve body 54 to be separated from the seat portion 46A to open the port 46. The plunger 53 generates a thrust force upon a power supply to the coil 57, and moves against the spring force of the return spring 56 in a valve-closing direction for causing the valve body 54 to be seated onto the seat portion 46A to close the port 46.

A plate 59 molded and integrated together with the coil 57 is sandwiched between the piston bolt 5 and the piston rod body 4 inserted in or screwed into the piston bolt 5, by which the pilot valve 13 is fixed.

The compression-side damping force generation mechanism 10 includes the disk valve 51 disposed on an end of the piston 4 on the cylinder upper chamber 2A side, and an orifice 51B formed at the disk valve 51. The disk valve 51 is opened by receiving a pressure of the oil in the passages 3.

An operation of the thus-configured present exemplary embodiment will be described next.

The damping force adjustable shock absorber 1 is mounted in the suspension apparatus of the vehicle between a sprung side and an unsprung side. The damping force adjustable shock absorber 1 supplies power to the coil 5 of the extension-side damping force generation mechanism 9 according to an instruction from an in-vehicle controller or the like to cause the plunger 53 to generate a thrust force to seat the valve body 54 onto the seat portion 46A, thereby performing pressure control by the pilot valve 13.

During an extension stroke of the piston rod 4, 5, a movement of the piston 3 causes the oil to be transmitted from the cylinder upper chamber 2A side to the cylinder lower chamber 2B side via the passages 7 of the piston 3 and then the extension-side damping force generation mechanism 9, whereby a damping force is generated by the extension-side damping force generation mechanism 9. Further, during a compression stroke of the piston rod 4, 5, the oil is transmitted from the cylinder lower chamber 2B side to the cylinder upper chamber 2A side via the passages 8 of the piston 3 and then the compression-side damping force generation mechanism 10, whereby a damping force is generated by the compression-side damping force generation mechanism 10.

At the extension-side damping force generation mechanism 9, the oil transmitted from the cylinder upper chamber 2A side to the cylinder lower chamber 28 side via the passages 7 of the piston 3 is mainly conveyed through the following three flow passages.

(1) Main Flow Passage

The oil on the cylinder upper chamber 2A side is conveyed from the oil passages 7 of the piston 3 to the orifice 18A of the main valve 11, or opens the disk valve 18 to be directly conveyed to the cylinder lower chamber 2B side.

(2) Control Flow Passage

The oil on the cylinder upper chamber 2A side is introduced from the passages 7 of the piston 3 into the pilot chamber 22 via the fixed orifice 23 of the disk valve 18, and is further delivered from the pilot chamber 22 to the cylinder lower chamber 2B side by being conveyed through the passages 24 of the main body 14 and opening the disk valve 28 of the control valve 12.

(3) Pilot Flow Passage

The oil on the cylinder upper chamber 2A side is conveyed from the passages 7 of the piston 3 into the passage 34 in the piston bolt 5 via the cutouts 18B and 19A formed at the inner circumferential portions of the disk valve 18 and the retainer 19, the passage 39 between the main body 14 and the piston bolt 5, the filter 35, the fixed orifice 36A of the orifice member 36, and the cutout 37A of the spacer 37 in the space C, and the passage 40 formed through the sidewall of the distal end portion 5C of the piston bolt 5. The oil in the passage 34 of the piston bolt 5 is introduced into the pilot chamber 32 via the passage 33 formed through the sidewall of the distal end portion 5C of the piston bolt 5 and the cutout 29A of the washer 29.

The oil introduced into the passage 34 in the piston bolt 5 is further transmitted into the valve chamber 47 by being conveyed through the passage 45 and the port 46 of the port member 42 of the pilot valve 13 and opening the valve body 54. Then, the oil is delivered from the valve chamber 47 into the cylinder lower chamber 2B via the axial groove 48, the passage 43A, the annular chamber 49, the passage 50, the cutouts 51A and 52A of the disk valve 51 and the retainer 52 of the compression-side damping force generation mechanism 10, and the passages 6 of the piston 3.

As a result, the damping force is generated by the main valve 11 of the extension-side damping force generation mechanism 9, the control valve 12, and the pilot valve 13 during the extension stroke of the piston rod (4, 5). At this time, the disk valve 18 of the main valve 11 is opened by receiving the pressure on the passage 7 side, and the inner pressure in the pilot chamber 22 formed on the back surface side is applied to the disk valve 18 in the valve closing direction. In other words, the disk valve 18 is opened by a differential pressure between the passage 7 side and the pilot chamber 22 side, whereby the valve-opening pressure varies depending on the inner pressure in the pilot chamber 22 in such a manner that a reduction in the inner pressure results in a reduction in the valve-opening pressure while an increase in the inner pressure results in an increase in the valve-opening pressure.

Further, the disk valve 28 of the control valve 12 is opened by receiving the pressure on the passage 24 side, and the inner pressure in the pilot chamber 32 formed on the back surface side is applied to the disk valve 23 in the valve-closing direction. In other words, the disk valve 28 is opened by a differential pressure between the passage 24 side and the pilot chamber 32 side, whereby the valve-opening pressure varies depending on the inner pressure in the pilot chamber 32 in such a manner that a reduction in the inner pressure results in a reduction in the valve-opening pressure while an increase in the inner pressure results in an increase in the valve-opening pressure.

When the piston speed is in a low-speed region, the main valve 11 and the control valve 12 are closed so that the oil is transmitted from the cylinder upper chamber 2A side to the cylinder lower chamber 2B side mainly via the above-described pilot flow passage (3), and the damping force is generated by the pilot valve 13. Then, the pressure on the upstream side of the pilot valve 13 is increased according to an increase in the piston speed. At this time, the inner pressures in the pilot chambers 22 and 32 located on the upstream side of the pilot valve 13 are controlled by the pilot valve 13, and are reduced when the pilot valve 13 is opened. As a result, first, the disk valve 28 of the control valve 12 is opened so that the oil is delivered into the reservoir via the above-described control flow passage (2) in addition to the above-described pilot flow passage (3) to suppress the damping force from being increased according to the increase in the piston speed.

When the disk valve 28 or the control valve 12 is opened, the inner pressure in the pilot chamber 22 is further reduced. The reduction in the inner pressure in the pilot chamber 22 causes the disk valve 18 of the main valve 11 to be opened and thus the oil to be transmitted to the cylinder lower chamber 23 side via the above-described main flow passage (1) in addition to the above-described pilot flow passage (3) and the above-described control flow passage (2) to suppress the damping force from being increased according to the increase in the piston speed.

An appropriate damping force characteristic can be acquired by the control of the increase in the damping force according to the increase in the piston speed in two steps in this manner. Then, the power supply to the coil 57 can adjust the control pressure of the pilot valve 13, which can control the inner pressure in the pilot chamber 32 of the control valve 12, i.e., the valve-opening pressure of the disk valve 28. Further, the controlled valve-opening pressure of the disk valve 28 can control the inner pressure in the pilot chamber 22 of the main valve 11, i.e., the valve-opening pressure of the disk valve 18.

As a result, a sufficient flow amount of the oil can be acquired by the opening of the disk valve 28 of the control valve 12 in addition to the pilot valve 13 in a valve-closing region of the main valve 11 (the low-speed region of the piston speed), which allowing the pilot valve 13 to have a small flow amount (i.e., an area of the flow passage of the port 46) to thereby achieve a reduction in the size of the pilot valve 13 (the solenoid valve) and power saving of the coil 57. Further, the damping force can be adjusted in two steps by the main valve 11 and the control valve 12, which allows the damping force characteristic to be further flexibly and freely adjusted and thus an appropriate damping force to be acquired.

Since the flow amount through the pilot valve 13 is small as described above, the fixed orifice 36A should have a sufficiently reduced area of the flow passage, whereby the filter 35 is desired to be provided to remove a foreign object in the oil to prevent the fixed orifice 36A from being clogged. The filter 35 is disposed on the upstream side of the fixed orifice 36A in the above-described pilot flow passage (3) to catch the foreign object in the oil, which can prevent or suppress the fixed orifice 36A from being clogged to thereby generate a stable damping force.

The diameter of the distal end portion 5C of the piston bolt 5 is reduced so that the annular space C is formed between the distal end portion 5C and the main body 14, and the filter 35 and the fixed orifice 36A (the orifice member 36) are disposed in this annular space C. This configuration allows the filter 35 and the fixed orifice 36A to be disposed without requiring increases in the inner diameters and the outer diameters of the disk valves 18 and 28 of the main valve 11 and the control valve 12, and the diameter of the cylinder 2.

Increasing the inner diameters of the disk valves 18 and 23 of the main valve 11 and the control valve 12 leads to an increase in the stiffness of the disk valves 18 and 28 and thus an increase in the soft-side damping force, which makes it difficult to acquire an appropriate damping force. Further, increasing the outer diameters of the disk valves 18 and 28 leads to an increase in the size of the damping force adjustable shock absorber.

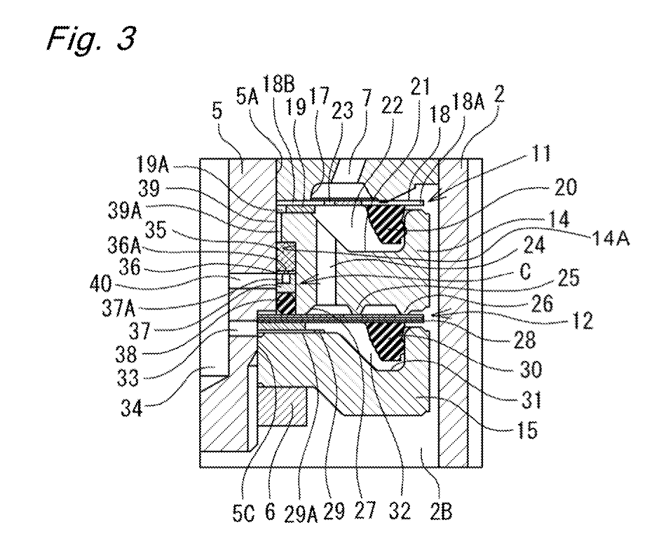

Next, a second embodiment of the present invention will be described with reference to FIG. 3. In the following description, similar features to the above-described first embodiment will be identified by the same reference numerals, and only different features will be illustrated in the drawing and be described in detail.

In the present embodiment, as illustrated in FIG. 3, the small-diameter portion 5A of the piston bolt 5 is extended to the end of the main body (the lower end in FIG. 3), and a large-diameter portion 14A is formed at the inner circumferential portion of the main body 14 so that the annular space C is formed between the small-diameter potion 5A of the piston bolt 5 and the large-diameter portion 14A of the main body 14. Then, the filter 35, the orifice member 36, the spacer 37, and the seal member 38 are fitted in this annular space. Further, a groove 39A is formed on the inner circumferential surface of the main body 14 so as to extend along the axial direction, which forms the passage 39 between the outer circumferential portion of the small-diameter portion 5A of the piston bolt 5 and the inner circumferential portion of the main body 14.

This configuration allows the second embodiment to include the filter 35 and the fixed orifice 36A without requiring the increases in the inner diameters and the outer diameters of the disk valves 18 and 28 of the main valve 11 and the control valve 12, and the diameter of the cylinder 2, acquire an appropriate damping force characteristic, and also suppress the increase in the size of the apparatus, in a similar manner to the above-described first embodiment.

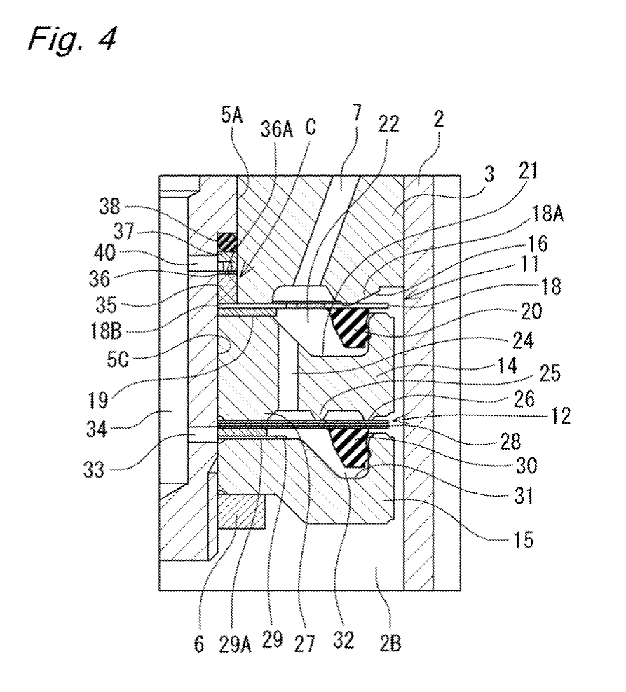

Next, a third embodiment of the present invention will be described with reference to FIG. 4. In the following description, similar features to the above-described first embodiment will be identified by the same reference numerals, and only different features will be illustrated in the drawing and be described in detail.

In the present embodiment, the filter 35, the orifice member 36, the spacer 37, and the seal member 38 are disposed between the piston bolt 5 and the piston 3 as illustrated in FIG. 4. The distal end portion 5C of the piston bolt 5 that is reduced in diameter is extended from a generally central position of the piston 3 in the axial direction, and the main body 14 and the control body 15 are fitted to the distal end portion 5C. Then, the annular space C is formed between the outer circumferential surface of the distal end portion 5C of the piston bolt 5 and an inner circumferential surface of the piston 3 that is the annular member. The filter 35, the orifice member 36, the spacer 37, and the seal member 38 are fitted in this annular space C. These are disposed in the order of the seal member 38, the spacer 37, the orifice member 36, and the filter 35 from the large-diameter 58 side of the piston bolt 5.

The annular space C is in direct communication with the cutout 18B of the disk valve 18 of the main valve 11. A seal is provided between the piston bolt 5 and the main body 14, and the passage 39 (the gap) is not formed therebetween. Due to this configuration, in the above-described pilot flow passage (3), the oil is introduced from the passages into the annular space C via the cutout 18B of the disk valve 18, and is delivered into the passage 34 in the piston bolt 5 via the filter 35, the fixed orifice 36A, the cutout 37A of the spacer 3, and the passage 40.

The third embodiment is configured in this manner, which allows the third embodiment to include the filter 35 and the fixed orifice 36A without requiring the increases in the inner diameters and the outer diameters of the disk valves 18 and 23 of the main valve 11 and the control valve 12, and the diameter of the cylinder 2, acquire an appropriate damping force characteristic, and also suppress the increase in the site of the apparatus, in a similar manner to the above-described first embodiment.

In the above-described first to third embodiments, the filter 35 and the fixed orifice 36A (the orifice member 36) are disposed in the annular space C formed between the piston bolt 5, which is a part of the piston rod 4, 5 as the shaft-like member, and the main body 14 or the piston 3 as the annular member. However, the present invention is not limited thereto, and the filter 35 and the fixed orifice 36A may be disposed between another shaft-like member and another annular member.

Further, in a case where the control valve 12 is not provided, the shock absorber may be configured in such a manner that the hydraulic fluid is introduced into the pilot chamber 22 of the main valve 11 after passing through the filter 35 and the fixed orifice 36A. For example, a passage can be formed in the main body 14 so as to establish communication between an exit side of the orifice 36A and the pilot chamber 22 or the passage 24 to thereby cause the hydraulic fluid to be introduced into the pilot chamber 22 after passing through the filter 35 and the fixed orifice 36A. In this case, the hydraulic pressure in the passage 34, and thus the pilot chamber 22 is adjusted by the pilot valve 13.

According to one embodiment of the present invention, a damping force adjustable shock absorber includes a cylinder sealingly containing hydraulic fluid, a piston slidably fitted in the cylinder, a piston rod coupled to the piston and extending out of the cylinder, and a damping force generation mechanism configured to generate a damping force by controlling a flow of the hydraulic fluid that is caused by a sliding movement of the piston in the cylinder. The damping force generation mechanism includes a pilot-type damping valve configured to be opened by receiving a pressure of the hydraulic fluid to generate the damping force. The pilot-type damping valve has a valve-opening pressure adjusted according to an inner pressure in a pilot chamber into which the hydraulic fluid is introduced. A valve body of the pilot-type damping valve and a plurality of annular members including a member forming the pilot chamber are fixed to a shaft-like member inserted therethrough with a space formed between one of the annular members and the shaft-like member. At least one of a filter and a fixed orifice is disposed in the space. The hydraulic fluid is introduced into the pilot chamber via the filter and the fixed orifice.

The damping force adjustable shock absorber may be configured in such a manner that the space is annular, and the filter having an annular shape and an annular orifice member in which the fixed orifice is formed are disposed in the space, the orifice member being disposed on a downstream side of the filter.

The damping force adjustable shock absorber may be configured in such a manner that the shaft-like member is the piston rod.

The damping force adjustable shock absorber may be configured in such a manner that the damping force generation mechanism includes a pilot-type control valve configured to control the inner pressure in the pilot chamber of the pilot-type damping valve, and a solenoid valve configured to control an inner pressure in a pilot chamber of the control valve.

The damping force adjustable shock absorbers according to the above-described embodiments can maintain the required adjustable range of the damping force characteristic, and include the filter for preventing the fixed orifice, which introduces the fluid into the pilot chamber, from being clogged without requiring the increase in the size of the shock absorber.

Although only some exemplary embodiments of this invention have been described in detail above, those skilled in the art will readily appreciate that many modifications are possible in the exemplary embodiments without materially departing from the novel teaching and advantages of this invention. Accordingly, all such modifications are intended to be included within the scope of this invention.

This application claims priority under the Paris Convention to Japanese Patent Application No. 2014-072022 filed on Mar. 31, 2014.

The entire disclosure of Japanese Patent Application No. 2014-072022 filed on Mar. 31, 2014 including specification, claims, drawings and summary is incorporated herein by reference in its entirety.

The entire disclosure of Japanese Patent Application Publication No. 2009-281584 including specification, claims, drawings and summary is incorporated herein by reference in its entirety.

What is claimed is:

1. A damping force adjustable shock absorber comprising:
a cylinder sealingly containing hydraulic fluid;
a piston slidably fitted in the cylinder;
a piston rod coupled to the piston and extending out of the cylinder; and
a damping force generation mechanism configured to generate a damping force by controlling a flow of the hydraulic fluid that is caused by a sliding movement of the piston in the cylinder, the damping force generation mechanism including a pilot-type damping valve configured to be opened by receiving a pressure of the hydraulic fluid to generate the damping force, the pilot-type damping valve having a valve-opening pressure adjusted according to an inner pressure in a pilot chamber into which the hydraulic fluid is introduced,
wherein a valve body of the pilot-type damping valve and a plurality of annular members including a member forming the pilot chamber are fixed to a shaft-like member inserted therethrough with a space formed between one of the annular members and the shaft-like member, and at least one of a filter and a fixed orifice is disposed in the space.

2. The damping force adjustable shock absorber according to claim 1, wherein the space is annular, and the filter having an annular shape and an annular orifice member in which the fixed orifice formed are disposed in the space, the orifice member being disposed on a downstream side of the filter.

3. The damping force adjustable shock absorber according to claim 1, wherein the shaft-like member is the piston rod.

4. The damping force adjustable shock absorber according to claim 2, wherein the shaft-like member is the piston rod.

5. The damping force adjustable shock absorber according to claim 1, wherein the damping force generation mechanism includes a pilot-type control valve configured to control the inner pressure in the pilot chamber of the pilot-type damping valve, and a solenoid valve configured to control an inner pressure in a pilot chamber of the control valve, and the hydraulic fluid is introduced into the pilot chamber of the control valve via the filter and the fixed orifice.

6. The damping force adjustable shock absorber according to claim 2, wherein the damping force generation mechanism includes a pilot-type control valve configured to control the inner pressure in the pilot chamber of the pilot-type damping valve, and a solenoid valve configured to control an inner pressure in a pilot chamber of the control valve, and the hydraulic fluid is introduced into the pilot chamber of the control valve via the filter and the fixed orifice.

7. The damping force adjustable shock absorber according to claim 3, wherein the damping force generation mechanism includes a pilot-type control valve configured to control the inner pressure in the pilot chamber of the pilot-type damping valve, and a solenoid valve configured to control an inner pressure in a pilot chamber of the control valve, and the hydraulic fluid is introduced into the pilot chamber of the control valve via the filter and the fixed orifice.

8. The damping force adjustable shock absorber according to claim 4, wherein the damping force generation mechanism includes a pilot-type control valve configured to control the inner pressure in the pilot chamber of the pilot-type damping valve, and a solenoid valve configured to control an inner pressure in a pilot chamber of the control valve, and the hydraulic fluid is introduced into the pilot chamber of the control valve via the filter and the fixed orifice.

9. The damping force adjustable shock absorber according to claim 1, wherein the hydraulic fluid is introduced into the pilot chamber of the pilot-type damping valve via the filter and the fixed orifice.
